(19) United States
(12) Patent Application Publication
(10) Pub. No.: US 2010/0203326 A1
(43) Pub. Date: Aug. 12, 2010

(54) AROMATIC LIQUID-CRYSTALLINE POLYESTER AMIDE COPOLYMER, PREPREG INCLUDING THE SAME, PREPREG LAMINATE INCLUDING THE PREPREG, METAL FILM LAMINATE INCLUDING THE PREPREG, AND PRINTED WIRING BOARD INCLUDING THE PREPREG

(76) Inventor: Tae Jun OK, Daejeon-city (KR)

Correspondence Address: Nixon Peabody LLP, P.O. Box 60610, Palo Alto, CA, 94306, US

(21) Appl. No.: 12/601,525

(22) PCT Filed: May 21, 2008
(86) PCT No.: PCT/KR2008/002824

§ 371 Date: Nov. 23, 2009

(30) Foreign Application Priority Data
May 23, 2007 (KR) 10-2007-0050435

(51) Int. Cl. C08G 65/40; C08G 69/08; B32B 17/10; B32B 27/36; B32B 27/06; C08L 77/00; B32B 15/09

(52) U.S. Cl. 428/337; 528/211; 528/331; 528/332; 428/430; 428/480; 524/606; 428/458

(57) ABSTRACT

A prepreg, a prepreg laminate including the prepreg, a metal film laminate including the prepreg, and a printed wiring board including the prepreg. The prepreg includes a woven or non-woven fabric substrate; and an aromatic liquid-crystalline polyester amide copolymer, wherein the woven or non-woven fabric substrate is impregnated with the aromatic liquid-crystalline polyester amide copolymer. Therefore, the prepreg is not deformed or does not cause blisters. In addition, the prepreg has low dielectric properties in a high frequency range. Also, a metal film of the metal film laminate or the printed wiring board does not corrode.

### CROSS-REFERENCE TO RELATED PATENT APPLICATIONS

This application is a national phase of PCT/KR2008/002824, entitled “AROMATIC LIQUID-CRYSTALLINE POLYESTER AMIDE COPOLYMER, PREPREG INCLUDING THE SAME, PREPREG LAMINATE INCLUDING THE PREPREG, METAL FILM LAMINATE INCLUDING THE PREPREG, AND PRINTED WIRING BOARD INCLUDING THE PREPREG, which was filed on May 21, 2008 and which claims priority of Korean Patent Application No. 10-2007-0050435, filed on May 23, 2007, in the Korean Intellectual Property Office, the disclosure of which is incorporated herein in its entirety by reference.

### BACKGROUND OF THE INVENTION

1. Field of the Invention

The present invention relates to an aromatic liquid-crystalline polyester amide copolymer, a prepreg including the aromatic liquid-crystalline polyester amide copolymer, a prepreg laminate including the pregreg, a metal film laminate including the pregreg, and a printed wiring board including the prepreg, and more particularly, to an aromatic liquid-crystalline polyester amide copolymer that is not deformed and does not cause blisters and has low dielectric characteristics in a high frequency range, a prepreg including the aromatic liquid-crystalline polyester amide copolymer, a prepreg laminate including the prepreg, a metal film laminate including the pregreg, and a printed wiring board including the prepreg.

2. Description of the Related Art

According to recent smallization and multifunctionalization of electronic devices, high densification and smallization of printed wiring boards are currently proceeding. Copper laminates are widely available materials that can be used as printed wiring boards for electronic devices due to their excellent stamping processability, drill processability, and low cost.

A prepreg used in a copper laminate for a printed wiring board should be suitable for semiconductor performances and semiconductor package manufacturing conditions. Thus, the prepreg should have the following principal properties:

(1) a low thermal expansion rate in response to a metal thermal expansion rate;

(2) a low dielectric property and dielectric stability in a high frequency range of 1 GHz or more; and

(3) heat resistance to a reflow process performed at around 270° C.

A prepreg is prepared by impregnating a glass fabric with a resin derived from epoxy or bismaletriazine and then semi-hardening the resin. Then, copper is deposited on the prepreg and the resin is hardened to form a copper laminate. The copper laminate is formed to be a thin layer and subjected to a high-temperature process, such as a reflow process performed at 270° C. When the copper laminate in the form of a thin layer is subjected to the high-temperature process, the copper laminate can be deformed and thus the yield of the copper laminate is decreased. Also, water-retaining characteristics of the resin derived from epoxy or bismaletriazine should be decreased. Specifically, the copper laminate has a low dielectric properties in the high frequency range of 1 GHz or more, and thus, has a problem difficult to be applied to a printed wiring board for a semiconductor package, wherein the board is subjected to a high-frequency and high-speed process. Therefore, there is a need to develop a low dielectic prepreg that does not cause such problems described above.

The prepreg can also be prepared with an aromatic liquid-crystalline polyester instead of the resin derived from epoxy or bismaletriazine. Such prepreg can be prepared by impregnating an organic or inorganic woven fabric with an aromatic liquid-crystalline polyester. In particular, an aromatic liquid-crystalline polyester prepreg can be'prepared with an aromatic liquid-crystalline polyester resin and an aromatic liquid-crystalline polyester woven fabric. Specifically, an aromatic liquid-crystalline polyester is dissolved in a solvent containing a halogen element, such as Cl, to prepare a composition solution, and an aromatic liquid-crystalline polyester woven fabric is impregnated with the composition solution and the resultant structure is dried to prepare an aromatic liquid-crystalline polyester prepreg. However, the solvent containing a halogen element cannot be completely removed, and the halogen element corrodes a copper film that is to be formed on the aromatic liquid-crystalline polyester prepreg. Therefore, the solvent containing a halogen element, that is, the halogen solvent, should be replaced with a non-halogen solvent.

### SUMMARY OF THE INVENTION

The present invention provides an aromatic liquid-crystalline polyester amide copolymer and a prepreg that is not deformed and does not cause blisters, due to inclusion of the aromatic liquid-crystalline polyester amide copolymer.

The present invention also provides a prepreg having a low dielectric property in a high frequency range.

The present invention also provides a prepreg laminate including the prepreg and a metal film laminate including the prepreg. The present invention also provides a printed wiring board including the prepreg.

According to an aspect of the present invention, there is provided an aromatic liquid-crystalline polyester amide copolymer obtained by polymerizing: (1) at least one compound selected from the group consisting of an aromatic hydroxy carboxylic acid, an ester forming derivative of the aromatic hydroxy carboxylic acid, an aromatic amino carboxylic acid, and an ester forming derivative of the aromatic amino carboxylic acid; (2) at least one compound selected from the group consisting of aromatic diamine, an amide forming derivative of the aromatic diamine, aromatic amine having a phenolic hydroxyl group, and an amide forming derivative of the aromatic amine having a phenolic hydroxyl group; and (3) an aromatic dicarboxylic acid or an ester forming derivative of the aromatic dicarboxylic acid.

According to another aspect of the present invention, there is provided a prepreg including: a substrate; and the aromatic liquid-crystalline polyester amide copolymer, wherein the substrate is impregnated with the aromatic liquid-crystalline polyester amide copolymer.

According to another aspect of the present invention, there is provided a prepreg laminate obtained by stacking at least one prepreg described above.

According to another aspect of the present invention, there is provided a metal film laminate obtained by forming a metal film on at least one surface of the prepreg laminate.

According to another aspect of the present invention, there is provided a printed wiring board obtained by etching the metal film of the metal film laminate.

### DETAILED DESCRIPTION OF THE INVENTION

The present invention will now be described in detail.

A prepreg according to an embodiment of the present invention includes a substrate and an aromatic liquid-crystalline polyester amide copolymer, wherein the substrate is impregnated with the aromatic liquid-crystalline polyester amide copolymer.

A method of preparing the prepreg will now be described in detail. A substrate is impregnated with a composition solution that is prepared by dissolving an aromatic liquid-crystalline polyester amide copolymer in a solvent. Alternatively, the composition solution may be coated on a substrate. Then the solvent used is removed.

Examples of the substrate may include a woven and/or non-woven fabric formed of aromatic liquid-crystalline polyester, glass, carbon, glass paper, or a mixture thereof. Specifically, use of a glass woven fabric substrate is desirable in terms of mechanical and electrical characteristics, and economical aspects.

The aromatic liquid-crystalline polyester amide copolymer can be any type of aromatic liquid-crystalline polyester amide copolymer that can be dissolved in a solvent. Desirably, the aromatic liquid-crystalline polyester amide copolymer may be a thermotropic liquid-crystalline polyester amide copolymer that is suitable for forming a molten product having optical anisotropy at 400° C. or lower. More desirably, a melting point of the aromatic liquid-crystalline polyester amide copolymer may be in a range of 250° C. to 400° C. When the melting point is less than 250° C., the substrate may be deformed because a soldering temperature of a printed wiring board in the subsequent substrate treatment process is higher than the melting point. On the other hand, when the melting point is higher than 400° C., the solubility of the copolymer with respect to the solvent is decreased. In addition, a number average molecular weight of the aromatic liquid-crystalline polyester amide copolymer may be in a range of 1000 to 20,000. When the number average molecular weight of the aromatic liquid-crystalline polyester amide copolymer is less than 1,000, liquid-crystallinity cannot be obtained. On the other hand, when the number average molecular weight of the aromatic liquid-crystalline polyester amide copolymer is greater than 20,000, solubility of the copolymer with respect to the solvent may be decreased.

The aromatic liquid-crystalline polyester amide copolymer described above may be obtained by, for example, polymerizing:

(1) at least one compound selected from the group consisting of an aromatic hydroxy carboxylic acid, an ester forming derivative of the aromatic hydroxy carboxylic acid, an aromatic amino carboxylic acid, an ester forming derivative of the aromatic amino carboxylic acid;

(2) at least one compound selected from the group consisting of aromatic diamine, an amide forming derivative of the aromatic diamine, aromatic amine having a phenolic hydroxyl group, and an amide forming derivative of the aromatic amine having a phenolic hydroxyl group; and

(3) an aromatic dicarboxylic acid or an ester forming derivative of the aromatic dicarboxylic acid.

30 mol % or less of aromatic diol compound may be further used together with the compounds (1), (2), and (3) to obtain the aromatic liquid-crystalline polyester amide copolymer, thereby increasing the polymerization reactivity. When the content of the aromatic diol compound is greater than 30 mole %, solubility of the copolymer with respect to the solvent may be decreased. The aromatic diol compound may include at least one compound selected from biphenol and hydroquinone.

The ester forming derivative of the aromatic hydroxy carboxylic acid, the aromatic amino carboxylic acid, or the aromatic dicarboxylic acid may be highly reactive derivatives, such as an acid chloride or an acid anhydride, or be a derivative that can form ester together with alcohols or ethylene glycol.

An amine group in the aromatic diamine or the amide forming derivative of the aromatic diamine can form an amide together with a carboxylic acid.

The aromatic liquid-crystalline polyester amide copolymer obtained as described above may include various repeating units in its chain. For example, the aromatic liquid-crystalline polyester amide copolymer may include repeating units, such as:

(1) repeating units derived from the aromatic hydroxy carboxylic acid, represented by:

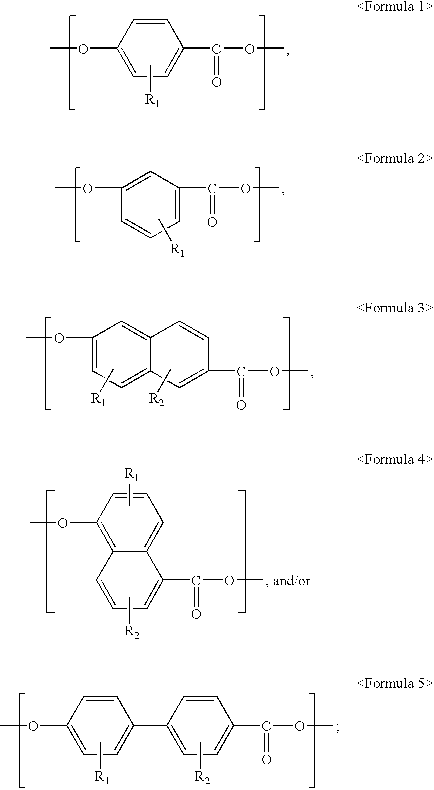

(2) repeating units derived from the aromatic amino carboxylic acid, represented by:

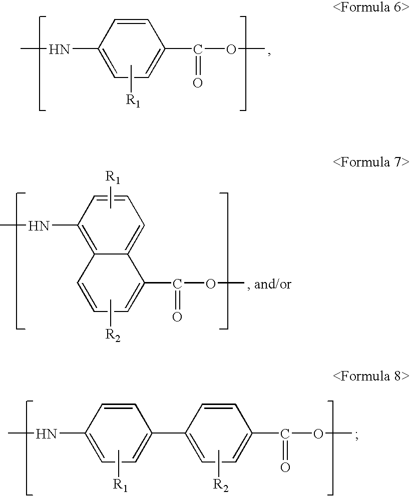

(3) repeating units derived from the aromatic diamine, represented by:

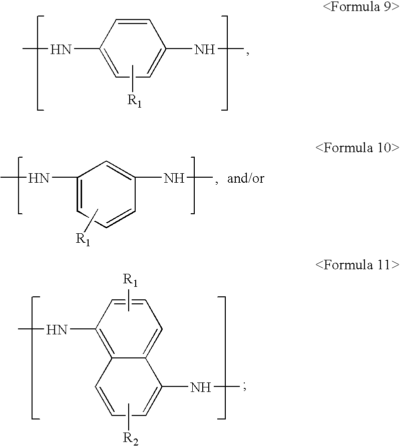

(4) repeating units derived from the aromatic amine having a phenolic hydroxyl group:

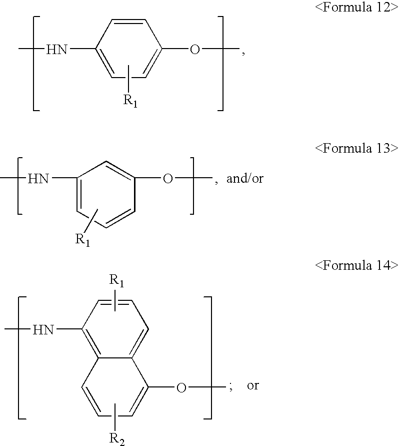

(5) repeating units derived from the aromatic dicarboxylic acid, represented by:

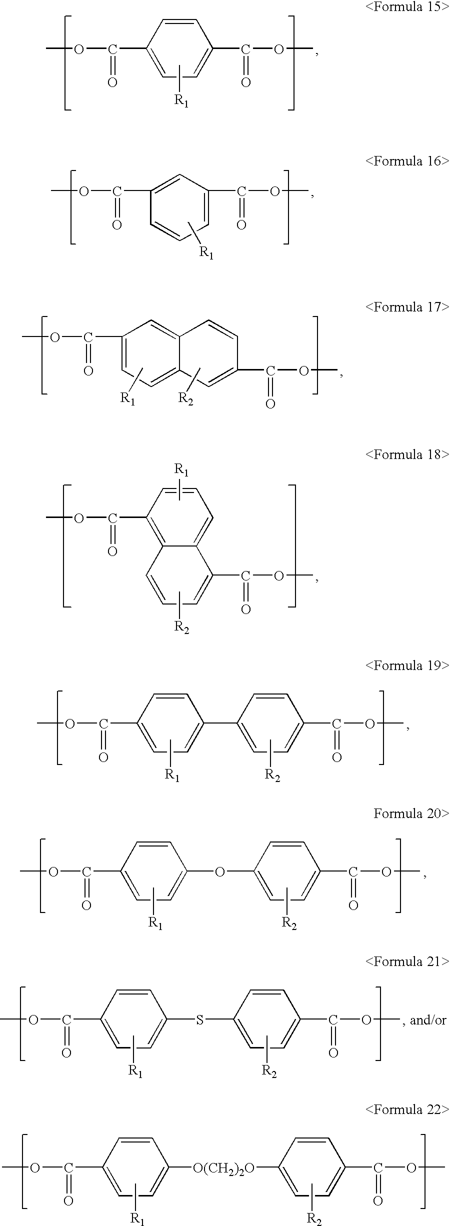

where R₁ and R₂ are identical to or different from each other, and are each a halogen atom, a carboxylic group, an amino group, a nitro group, a cyano group, a substituted or unsubstituted C₁-C₂₀ alkyl group, a substituted or unsubstituted C₁-C₂₀ alkoxy group, a substituted or unsubstituted C2-C20 alkenyl group, a substituted or unsubstituted C₂-C₂₀ alkynyl group, a substituted or unsubstituted C₁-C₂₀ hetero alkyl group, a substituted or unsubstituted C₆-C₃₀ aryl group, a substituted or unsubstituted C₇-C₃₀ aryl alkyl group, a substituted or unsubstituted C₅-C₃₀ heteroaryl group, or a substituted or unsubstituted C₃-C₃₀ heteroaryl alkyl group.

The aromatic liquid-crystalline polyester amide copolymer according to the present embodiment may include:

(1) 30 to 70 mole % of at least one repeating unit selected from a group consisting of a repeating unit derived from at least one compound selected from a group consisting of a para hydroxy benzoic acid and 2-hydroxy-6-naphthoeic acid, and a repeating unit derived from at least one compound selected from a group consisting of a 4-aminobenzoic acid, an 2-amino-naphthalene-6-carboxylic acid, and a 4-amino-biphenyl-4-carboxylic acid;

(2) 10 to 40 mole % of at least one repeating unit selected from a group consisting of a repeating unit derived from at least one compound selected from a group consisting of 1,4-phenylene diamine, 1,3-phenylene diamine, and 2,6-naphthalene diamine, and a repeating unit derived from at least one compound selected from a group consisting of 3-aminophenol, 4-aminophenol, and 2-amino-6-naphtol; and

(3) 10 to 40 mole % of a repeating unit derived from at least one compound selected from a group consisting of an isophthalic acid, a naphthalene dicarboxylic acid, and a terephthalic acid.

When the content of the repeating unit of (1) is less than 30 mole %, liquid crystallinity is decreased. On the other hand, when the content of the repeating unit of (1) is greater than 70 mole %, solubility of the copolymer with respect to the solvent is decreased. When the content of the repeating unit of (2) is less than 10 mole %, liquid-crystallinity is decreased. On the other hand, when the content of the repeating unit of (2) is greater than 40 mole %, solubility of the copolymer with respect to the solvent is decreased. When the content of the repeating unit of (3) is less than 10 mole %, solubility of the copolymer with respect to the solvent is decreased. On the other hand, when the content of the repeating unit of (3) is greater than 40 mole %, liquid-crystallinity is decreased.

The aromatic liquid-crystalline polyester amide copolymer described above may be prepared by using a conventional method of preparing aromatic liquid-crystalline polyester. For example, an aromatic hydroxy carboxylic acid corresponding to the repeating unit of (1), and an aromatic diamine or a phenolic hydroxyl or amide group of the aromatic diamine corresponding to the repeating unit of (2) are acylated with an excess amount of fatty acid anhydride to obtain an acylation product, and the obtained acylation product is melt-polymerized through transesterification and transamidation with at least one compound selected from a group consisting of an aromatic hydroxy carboxylic acid and an aromatic dicarboxylic acid

In the acylation reaction, the content of the fatty acid anhydride used may be in a range of 1.0 to 1.2 times, specifically 1.04 to 1.07 times greater than that of the phenolic hydroxyl or amide group, in terms of a chemical equivalent. When the content of the fatty acid anhydride is above the range, coloration of the aromatic liquid-crystalline polyester amide copolymer may be prominent. On the other hand, when the content of the fatty acid anhydride is below the range, some of the monomers used may be evaporated from the copolymer or more phenol gas may be generated. The acylation reaction may be performed at a temperature ranging from 130 to 170° C. for 30 minutes to 8 hours, specifically, a temperature ranging from 140 to 160° C. for 2 hours to 4 hours.

The fatty acid anhydride used in the acylation reaction may be an anhydrous acetic acid, an anhydrous propionic acid, an anhydrous isobutyric acid, an anhydrous valeric acid, an anhydrous pivalic acid, an anhydrous butyric acid, or a combination thereof, but is not limited thereto. Specifically, use of anhydrous acetic acid is desirable in terms of costs and handling convenience.

The transesterification and transamidation reaction may be performed at a temperature ranging from 130 to 400° C. while the reaction temperature is increased by 0.1 to 2 [symbol] /minute, specifically at a temperature ranging from 140 to 350 [symbol] while the reaction temperature is increased by 0.3 to 1° C./minute.

To move the equilibrium state when the fatty acid ester obtained as a result of the acylation is transesterified or transamidated with the carboxylic acid, fatty acids by-produced and unreacted anhydrides may be removed by evaporation or distillation to outside the reaction system.

The acylation reaction, the transesterification reaction, and the transamidation reaction may be performed in the presence of a catalyst. The catalyst may be any catalyst that is used to prepare polyester. Examples of the catalyst include a magnesium acetic acid, a first tin acetic acid, a tetrabutyltitanate, a lead acetic acid, a sodium acetic acid, a potassium acetic acid, antimony trioxide, N,N-dimethylaminopyridine, and N-methylimidazole. The catalyst and monomers are usually added at the same time, and the acylation reaction and the transesterification reaction are performed without removal of the catalyst.

Generally, the polymerization condensation reaction performed by transesterification and transamidation is achieved by a molten polymerization reaction. The molten polymerization reaction can be performed together with a solid state polymerization reaction.

The type of a polymerization reactor in which the molten polymerization reaction is performed is not limited. In general, the polymerization reactor may be a reactor equipped with a mixer used for a high-viscosity reaction. The acylation and the molten polymerization reaction may be performed in the same reactor or in different reactors.

The solid state polymerization reaction may be performed after a prepolymer obtained from the molten polymerization reaction is milled into the form of flakes or powder. Specifically, the solid sate polymerization reaction may be performed by heat treating in a solid state in an inert atmosphere such N₂ gas at a temperature ranging from 200 to 350° C. for 1 to 30 hours. The solid state polymerization reaction may be performed while mixing or not mixing. The molten polymerization reaction and the solid state polymerization reaction may be performed in the same reactor having an appropriate mixing device. The obtained aromatic liquid-crystalline polyester amide copolymer may be formed in pellets and then subjected to a molding process. Also, the obtained aromatic liquid-crystalline polyester amide copolymer can be formed in the form of fabric, and thus can be used to prepare a woven fabric or non-woven fabric.

The aromatic liquid-crystalline polyester amide copolymer described above is dissolved in a solvent to prepare a composition solution, and then an organic or inorganic woven and/or non-woven fabric is impregnated or coated with the composition solution, thereby forming a prepreg that is suitable for a multi-layer printed wiring board, or a substrate for laminates. In this regard, an available molding method may be a solution impregnating method or a varnish impregnating method.

The content of the solvent used to dissolve the aromatic liquid-crystalline polyester amide copolymer may be in a range of 100 to 100,000 parts by weight based on 100 parts by weight of the aromatic liquid-crystalline polyester amide copolymer. When the content of the solvent is less than 100 parts by weight based on 100 parts by weight of the aromatic liquid-crystalline polyester amide copolymer, the viscosity of the composition solution is increased and solubility of the copolymer with respect to the solvent may be decreased. On the other hand, when the content of the solvent is greater than 100,000 parts by weight based on 100 parts by weight of the aromatic liquid-crystalline polyester amide copolymer, the content of the aromatic liquid-crystalline polyester amide copolymer is relatively small and productivity may be decreased.

The solvent used to dissolve the aromatic liquid-crystalline polyester amide copolymer may be a non-halogen solvent, but is not limited thereto. For example, the solvent may be a polar non-proton based compound, halogenated phenol, o-dichlorobenzene, chloroform, methylene chloride, tetrachloroethane, or a combination thereof. Specifically, the present embodiment does not use a halogen element-containing solvent because the aromatic liquid-crystalline polyester amide copolymer can be dissolved even in a solvent that does not contain halogen. Therefore, a metal film laminate including the copolymer or a metal film of a printed wiring board including the copolymer can be protected from corrosion caused by a halogen element-containing solvent.

When the process of preparing the prepreg includes an impregnating process in which the substrate is impregnated with the composition solution prepared by dissolving the aromatic liquid-crystalline polyester amide copolymer in the solvent, the impregnating time may be in a range of 0.001 minutes to 1 hour. When the impregnating time is less than 0.001 minutes, the aromatic liquid-crystalline polyester amide copolymer may not be homogeneously impregnated. On the other hand, when the impregnating time is greater than 1 hour, the productivity may be decreased.

Also, in the impregnating process in which the substrate is impregnated with the composition solution prepared by dissolving the aromatic liquid-crystalline polyester amide copolymer in the solvent, the impregnating temperature may be in a range of 20 to 190 [symbol] , specifically at room temperature.

In addition, the impregnated content of the aromatic liquid-crystalline polyester amide copolymer per unit area of the substrate may be in a range of 0.1 to 1000 g/m². When the content of the aromatic liquid-crystalline polyester amide copolymer is less than 0.1 g/m², productivity may be decreased. On the other hand, when the impregnated content of the aromatic liquid-crystalline polyester amide copolymer is greater than 1000 g/m², the viscosity of the composition solution may be high and processability may be decreased.

Without departing from the scope of the present invention, the composition solution prepared by dissolving the aromatic liquid-crystalline polyester amide copolymer in the solvent may further include an inorganic filler, such as silica, aluminum hydroxide, or calcium carbonate; or an organic filler, such as cured epoxy or crosslinked acryl, in order to control dielectric constant and a thermal expansion rate. Specifically, the composition solution includes inorganic filler having a high dielectric property. The inorganic filler may be titanate, such as barium titanate or strontium titanate, or a compound obtained by substituting titanium or barium of barium titanate with other metals. The content of the inorganic or organic filler may be in a range of 0.0001 to 100 parts by weight based on 100 parts by weight of the aromatic liquid-crystalline polyester amide copolymer. When the content of the inorganic or organic filler is less than 0.0001 parts by weight based on 100 parts by weight of the aromatic liquid-crystalline polyester amide copolymer, it is difficult to sufficiently increase dielectric property of the copolymer or decrease a thermal expansion rate of the copolymer. On the other hand, when the content of the inorganic or organic filler is greater than 100 parts by weight based on 100 parts by weight of the aromatic liquid-crystalline polyester amide copolymer, the binding effect of the aromatic liquid-crystalline polyester amide copolymer may be decreased.

Since the copolymer impregnated substrate according to the present embodiment includes the aromatic liquid-crystalline poly ester amide copolymer having low water retaining capability and a low dielectric property and an organic or inorganic woven and/or non-woven fabric having excellent mechanical strength, the copolymer impregnated substrate has excellent dimensional stability, is hardly deformed when exposed to heat, and is hard. Due to these characteristics, the copolymer impregnated substrate is suitable for a via-hole drill processing and a stacking processing.

In the impregnating process for preparing the prepreg, after the substrate is impregnated or coated with the composition solution prepared by dissolving the aromatic liquid-crystalline polyester amide copolymer in the solvent the solvent may be removed by, for example, solvent evaporation, such as heat evaporation, vacuum evaporation, or ventilation evaporation. Specifically, use of heat evaporation, specifically ventilation heating evaporation, is desirable in terms of applicability to a conventional prepreg manufacturing process, production efficiency, and handing convenience.

In the process of removing the solvent, the composition solution of the aromatic liquid-crystalline polyester amide copolymer obtained as described above may be pre-dried at a temperature ranging from 20 to 190° C. for 1 minute to 2 hours, and then the resultant composition solution is heat treated at a temperature ranging from 190 to 350° C. for 1 minute to 10 hours.

The thickness of the prepreg according to the present invention obtained as described above may be in a range of about 5 to 200 μm, preferably about 30 to 150 μm. A one-directional thermal expansion coefficient of the prepreg may be in a range of 3 to 10 ppm/° C., and a dielectric constant of the prepreg may be 3.5 or less. When the thermal expansion coefficient is less than 3 ppm/° C., a printed wiring board including the prepreg may be deformed in the substrate treatment process, for example, a heat treating process, or the prepreg may be separated from a metal film. On the other hand, when the thermal expansion coefficient is greater than 10 ppm/° C., prepregs of a prepreg laminate may be separated from each other. When the dielectric constant of the prepreg is greater than 3.5, the prepreg may be insufficient for an insulating substrate in a high frequency range.

A prepreg laminate including the prepreg according to an embodiment of the present invention may be prepared by stacking a predetermined number of prepregs prepared as described above and then heating and compressing the stacked prepregs.

A metal film laminate according to an embodiment of the present invention may be prepared by disposing a metal film, such as a copper film, a silver film, or an aluminum film, on at least one surface of the prepreg laminate prepared as described above, and heating and compressing the resultant structure. In the metal film laminate, the thickness of each of the prepreg laminate and the metal film may not be limited and may be in a range of 0.1 to 300 [symbol] . When the thickness of the prepreg laminate is less than 0.1 μm, the prepreg laminate may crack when a rolling process is performed thereon. On the other hand, when the thickness of the prepreg laminate is greater than 300 μm, the number of prepregs that can be stacked is limited. When the thickness of the metal film is less than 0.1 μm, the metal film may crack when the metal film is stacked on the prepreg laminate. On the other hand, when the thickness of the metal film is greater than 300 μm, the number of prepregs that can be stacked is limited.

In the method of preparing the metal film laminate, the heating and compressing process may be performed at a temperature ranging from 150 to 180° C. at a pressure ranging from 9 to 20 MPa. However, the heating temperature and the pressure are not limited thereto. That is, the heating temperature and the pressure may be appropriately determined in consideration of characteristics of prepregs, reactivity of the composition solution of the aromatic liquid-crystalline polyester amide copolymer, a performance of a pressing device, a thickness of the target metal film laminate, or the like.

The metal film laminate according to the present embodiment may further include an adhesive layer between the prepreg laminate and the metal film to increase an adhesive force therebetween. The adhesive layer may be formed of a thermoplastic resin composition or a thermosetting resin composition. The thickness of the adhesive layer may be in a range of 0.1 to 100 μm. When the thickness of the adhesive layer is less than 0.1 μm, the adhesive force may be too low. On the other hand, when the thickness of the adhesive layer is greater than 100 μm, the adhesive layer is too thick.

Also provided is a printed wiring board including the metal film laminate, according to an embodiment of the present invention. The printed wiring board according to the present embodiment may be prepared by, for example, etching the metal film of the metal film laminate and forming a circuit. When required, a through-hole can also be formed. A multi-layer printed wiring board according to an embodiment of the present invention may be prepared by, for example, disposing a predetermined number of prepregs described above between an inner layer (i.e., substrate) and a metal film in consideration of a thickness of an insulating layer to be formed, and molding the resultant structure by heating and compressing. The heating and compressing conditions may be the same as in the method of preparing the metal film laminate. The inner layer may include at least one selected from a prepreg laminate used as an electric insulating material, a metal film laminate, and a printed wiring board.

The present invention will be described in further detail with reference to the following examples. These examples are for illustrative purposes only and are not intended to limit the scope of the present invention.

### Example 1

621.5 g of para hydroxy benzoic acid, 94.1 g of 2-hydroxy-6-naphthoeic acid, 273 g of 4-aminophenol, 415.3 g of isophthalic acid, and 1123 g of anhydrous acetic acid were added to a reactor equipped with a mixing device, a torquemeter, a nitrogen gas inlet, a thermometer, and a reflux condenser. The reactor was sufficiently purged with a nitrogen gas, and the temperature was increased in a nitrogen gas atmosphere to 150° C. for 30 minutes. The reaction mixture was refluxed for 3 hours while the temperature was maintained at 150° C.

Then, while the effluxed acetic acid and unreacted anhydrous acetic acid were removed by distillation, the temperature was increased to 320 [symbol] for 180 minutes. When torque began to increase, that is, when the reaction stopped, the reaction product was obtained. The obtained solid product was cooled to room temperature and milled using a miller. Then, a solid state polymerization reaction was performed in a nitrogen atmosphere while the temperature was maintained at 260° C. for 5 hours to obtain an aromatic liquid-crystalline polyester amide copolymer powder. The obtained powder was identified with a polarization microscope. As a result, a unique feature of a liquid crystal, that is, the shape of Sully Christopher Wren was identified at 400° C. or lower.

7 g of the obtained aromatic liquid-crystalline polyester amide copolymer powder was added to 93 g of N-methylpyrrolidinone (NMP), and then the resultant mixture was stirred at 120° C. for 4 hours to obtain a composition solution of the aromatic liquid-crystalline polyester amide copolymer.

A glass woven fabric (IPC 2116) was impregnated with the composition solution at 80° C., and then passed through a double roller to remove excess composition solution to obtain a uniform thickness. Then, the resultant glass woven fabric was loaded into a high-temperature thermal wind dryer in order to remove the solvent used at 120° C. Then, the resultant structure was heat treated at 300° C. for 60 minutes to obtain a prepreg in which the glass woven fabric was impregnated with the aromatic liquid-crystalline polyester amide copolymer.

### Example 2

A prepreg in which a glass woven fabric was impregnated with an aromatic liquid-crystalline polyester amide copolymer was prepared in the same manner as in Example 1, except that 448.9 g of para hydroxy benzoic acid, 9.4 g of 2-hydroxy-6-naphthoeic acid, 136.5 g of 4-aminophenol, 137.6 g of hydroquinone, 415.3 g of isophthalic acid, 171.4 g of para amino benzoic acid, and 1123 g of anhydrous acetic acid were used.

### Example 3

A prepreg in which a glass woven fabric was impregnated with an aromatic liquid-crystalline polyester amide copolymer was prepared in the same manner as in Example 1, except that 448.9 g of para hydroxy benzoic acid, 611.6 g of 2-hydroxy-6-naphthoeic acid, 177.3 g of 4-aminophenol, 89.5 g of hydroquinone, 87.9 g of 1,4-phenylenediamine, 539.9 g of isophthalic acid, and 1459.9 g of anhydrous acetic acid were used.

### Example 4

A prepreg in which a glass woven fabric was impregnated with an aromatic liquid-crystalline polyester amide copolymer and an inorganic filler was prepared in the same manner as in Example 1, except that 0.05 parts by weight of silica power calcined at high-purity (99% or more SiO₂, specific gravity: 2.2, d90: 13 μm, a thermal expansion rate: 0.5 ppm/° C., and a temperature ranging from 0 to 1000° C.) based on 100 parts by weight of the composition solution of the aromatic liquid-crystalline polyester amide copolymer prepared according to Example 1 was further added to the composition solution and dispersed therein.

The resin power separation and electrical characteristics of prepregs prepared according to Examples 1-4 were evaluated using the following method. The prepregs prepared according to Examples 1-4 were compared with a prepreg prepared by impregnating a glass woven fabric with epoxy resin (7409HGS produced by Doosan Co., Ltd.)

The pepregs prepared according to Examples 1-4 and the epoxy resin impregnated glass woven fabric (7409HGS) each were immersed in a solder bath at a soldering temperature of 290 [symbol] for one minute and the surface of each prepreg was observed. The prepregs prepared according to Examples 1-4 were not deformed and did not have blisters. However, a surface of the epoxy resin impregnated glass woven fabric (7409HGS) was locally peeled off and 7409HGS itself was deformed.

In addition, dielectric loss of each of the prepregs prepared according to Examples 1 through 4 and the epoxy resin impregnated glass woven fabric (7409HGS) was measured with an impedance analyzer. As a result, the dielectric constant of the prepreg prepared according to Example 1 was 2.9 (1 GHz), the dielectric constant of the prepreg prepared according to Example 2 was 2.8 (1 GHz), the dielectric constant of the prepreg prepared according to Example 3 was 3.0 (1 GHz), and the dielectric constant of the prepreg prepared according to Example 4 was 2.9 (1 GHz). Therefore, it is seen that the dielectric property of a prepreg according to the present invention is low in a high frequency range. However, the dielectric constant of the epoxy resin impregnated glass woven fabric (7409HGS) was 4.9 (1 GHz), 1.5 times greater than the dielectric constant of the prepregs prepared according to Examples 1 through 4.

Also, the thermal expansion rate of each of the prepregs prepared according to Examples 1-4 and the epoxy resin impregnated glass woven fabric (7409HGS) was measured using TMA. In a temperature range of 50 to 120° C., the thermal expansion rate of the prepreg prepared according to Example 1 was 8.8 ppm/° C., the thermal expansion rate of the prepreg prepared according to Example 2 was 7.0 ppm/° C., the thermal expansion rate of the prepreg prepared according to Example 3 was 9.5 ppm/° C., and the thermal expansion rate of the prepreg prepared according to Example 4 was 6.5 ppm/° C. All the thermal expansion rates were less than 10 ppm/ [symbol] . However, the thermal expansion rate of the epoxy resin impregnated glass woven fabric (7409HGS) was 14 ppm/° C. That is, the thermal expansion rates of the prepregs prepared according to Examples 1-4 were lower than the thermal expansion rate of the epoxy resin impregnated glass woven fabric (7409HGS).

Meanwhile, as described above, a prepreg laminate, a metal film laminate and a printed wiring board including the prepregs prepared according to the present invention can be manufactured by using conventional methods.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An aromatic liquid-crystalline polyester amide copolymer obtained by polymerizing:
(1) at least one compound selected from the group consisting of an aromatic hydroxy carboxylic acid, an ester forming derivative of the aromatic hydroxy carboxylic acid, an aromatic amino carboxylic acid, and an ester forming derivative of the aromatic amino carboxylic acid;
(2) at least one compound selected from the group consisting of aromatic diamine, an amide forming derivative of the aromatic diamine, aromatic amine having a phenolic hydroxyl group, and an amide forming derivative of the aromatic amine having a phenolic hydroxyl group; and
(3) an aromatic dicarboxylic acid or an ester forming derivative of the aromatic dicarboxylic acid.

2. The aromatic liquid-crystalline polyester amide copolymer of claim 1, wherein
a repeating unit derived from the aromatic hydroxy carboxylic acid comprises at least one of the structures represented by Formulae 1-5,
a repeating unit derived from the aromatic amino carboxylic acid comprises at least one of the structures represented by Formulae 6-8,
a repeating unit derived from the aromatic diamine comprises at least one of the structures represented by Formulae 9-11,
a repeating unit derived from the aromatic amine having a phenolic hydroxyl group comprises at least one of the structures represented by Formulae 12-14, and
a repeating unit derived from the aromatic dicarboxylic acid comprises at least one of the structures represented by Formulae 15-22: 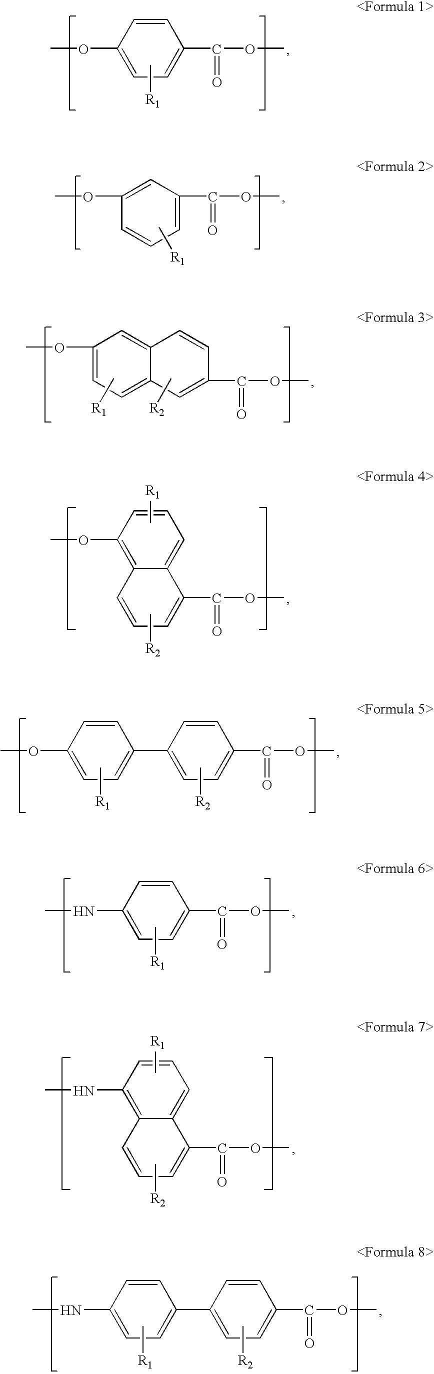 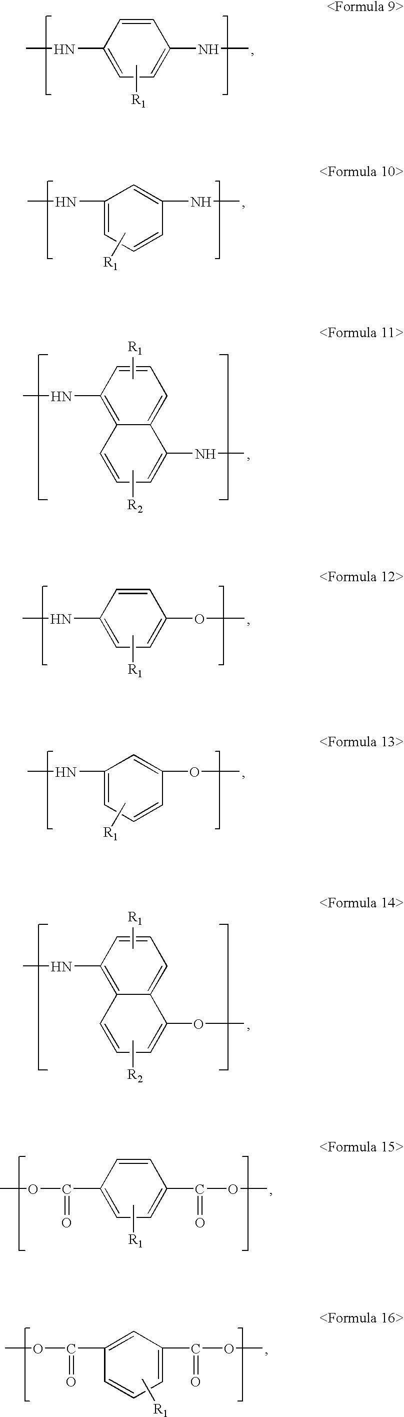 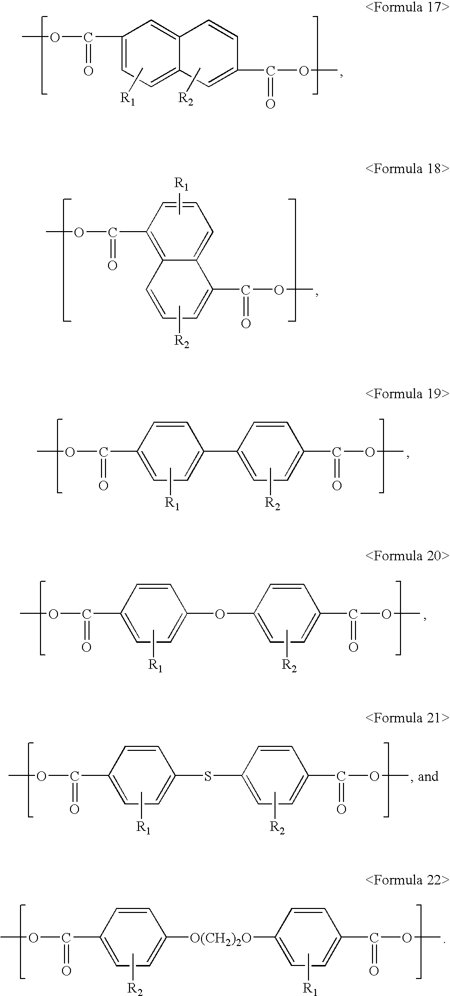
where R₁ and R₂ are identical to or different from each other, and are each a halogen atom, a carboxylic group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ aryl alkyl group, a substituted or unsubstituted C₅-C₃₀ heteroaryl group, and a substituted or unsubstituted C₃-C₃₀ heteroaryl alkyl group.

3. The aromatic liquid-crystalline polyester amide copolymer of claim 1, comprising:
30 to 70 mole % of at least one repeating unit selected from a group consisting of a repeating unit derived from at least one compound selected from a group consisting of a para hydroxy benzoic acid and 2-hydroxy-6-naphthoeic acid, and a repeating unit derived from at least one compound selected from a group consisting of a 4-aminobenzoic acid, an 2-amino-naphthalene-6-carboxylic acid, and a 4-amino-biphenyl-4-carboxylic acid;
10 to 40 mole % of at least one repeating unit selected from a group consisting of a repeating unit derived from at least one compound selected from a group consisting of 1,4-phenylene diamine, 1,3-phenylene diamine, and 2,6-naphthalene diamine, and a repeating unit derived from at least one compound selected from a group consisting of 3-aminophenol, 4-aminophenol, and 2-amino-6-naphtol; and
10 to 40 mole % of a repeating unit derived from at least one compound selected from a group consisting of an isophthalic acid, a naphthalene dicarboxylic acid, and a terephthalic acid.

4. The aromatic liquid-crystalline polyester amide copolymer of claim 1, wherein a number average molecular weight of the aromatic liquid-crystalline polyester amide copolymer is in a range of 1,000 to 20,000 and a melting point of the aromatic liquid-crystalline polyester amide copolymer is in a range of 250 to 400° C.

5. The aromatic liquid-crystalline polyester amide copolymer of claim 1, wherein the aromatic liquid-crystalline polyester amide copolymer is obtained by polymerizing the compound of (1), the compound of (2), the compound of (3), and 30 mole % or less of an aromatic diol compound.

6. The aromatic liquid-crystalline polyester amide copolymer of claim 5, wherein the aromatic diol compound comprises at least one of biphenol and hydroquinone.

7. A prepreg comprising:
a substrate; and
the aromatic liquid-crystalline polyester amide copolymer obtained by polymerizing:
(1) at least one compound selected from the group consisting of an aromatic hydroxy carboxylic acid, an ester forming derivative of the aromatic hydroxy carboxylic acid, an aromatic amino carboxylic acid, and an ester forming derivative of the aromatic amino carboxylic acid;
(2) at least one compound selected from the group consisting of aromatic diamine, an amide forming derivative of the aromatic diamine, aromatic amine having a phenolic hydroxyl group, and an amide forming derivative of the aromatic amine having a phenolic hydroxyl group; and
(3) an aromatic dicarboxylic acid or an ester forming derivative of the aromatic dicarboxylic acid, wherein the substrate is impregnated with the aromatic liquid-crystalline polyester amide copolymer.

8. The prepreg of claim 7, wherein the impregnated content of the aromatic liquid-crystalline polyester amide copolymer per unit area of the substrate is in a range of 0.1 to 1000 g/m² and the thickness of the substrate is in a range of 5 to 200 μm.

9. The prepreg of claim 7, wherein the substrate comprises at least one material selected from the group consisting of aromatic liquid-crystalline polyester, glass, carbon, and glass paper.

10. The prepreg of claim 7, further comprising an organic or inorganic filler, wherein the content of the organic or inorganic filler is 0.0001 to 100 parts by weight based on 100 parts by weight of the aromatic liquid-crystalline polyester amide copolymer.

11. The prepreg of claim 7, wherein a one-directional thermal expansion coefficient of the prepreg is in a range of 3 to 10 ppm/° C., and a dielectric constant of the prepreg is 3.5 or less.

12. A prepreg laminate obtained by stacking at least one prepreg of claim 7.

13. A metal film laminate obtained by forming a metal film on at least one surface of the prepreg laminate, comprising:
a substrate; and
the aromatic liquid-crystalline polyester amide copolymer obtained by polymerizing:
(1) at least one compound selected from the group consisting of an aromatic hydroxy carboxylic acid, an ester forming derivative of the aromatic hydroxy carboxylic acid, an aromatic amino carboxylic acid, and an ester forming derivative of the aromatic amino carboxylic acid;
(2) at least one compound selected from the group consisting of aromatic diamine, an amide forming derivative of the aromatic diamine, aromatic amine having a phenolic hydroxyl group, and an amide forming derivative of the aromatic amine having a phenolic hydroxyl group; and
(3) an aromatic dicarboxylic acid or an ester forming derivative of the aromatic dicarboxylic acid, wherein the substrate is impregnated with the aromatic liquid-crystalline polyester amide copolymer.

14. The metal film laminate of claim 13, which provides a printed wiring board obtained by etching the metal film.
